(19) United States
(12) Patent Application Publication
(10) Pub. No.: US 2008/0024578 A1
(43) Pub. Date: Jan. 31, 2008

(54) END OF ROLL PAPER SENSING AND SYSTEM MANAGEMENT

(75) Inventors: James G. Brewington, Raleigh, NC (US); Robert A. Myers, Cary, NC (US); David W. Standhope, Cary, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/460,495

(22) Filed: Jul. 27, 2006

(51) Int. Cl. B41J 2/01

(52) U.S. Cl. 347/104

(57) ABSTRACT

A method for sensing an end of roll paper of a printer, the method comprising: providing one or more back sensors for detecting a set of first marks on the back of the roll paper for aligning text printed on the roll paper, the set of first marks having a first predetermined size; detecting the set of first marks on the back of the roll paper to convey first information to a user of the printer; and detecting a set of second marks to indicate to the user of the printer that the roll paper is ending, the set of second marks of a second predetermined size on side portions of the roll paper, the second set of marks having additional information and the second predetermined size being larger than the first predetermined size.

### TRADEMARKS

IBM® s a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method for managing paper on a point-of-service (POS) printer, and particularly to a method of sensing an end of roll paper of the POS printer.

2. Description of Background

A roll paper is made by winding a continuous long printing paper a number of times around a surface of a core. In a printing system using a roll paper, printing is carried out by successively feeding the roll paper to a printing position in accordance with generation of a print image. When printing of one page is finished, the printed roll paper is fed a predetermined amount, is subjected to cutting or the like at a predetermined position, and then is discharged. In a case where a printing system uses a roll paper, continuous long printing paper is supplied by predetermined amounts, and there is a possibility in that the roll paper will end in the middle of a printing job. Thus, there is a possibility in that a shortage in a remaining amount of roll paper will occur, and printing will be interrupted.

Systems management is a key component for providing efficient solutions to such problems. Systems management makes a difference between a device being available when needed and a device waiting on operator intervention while a customer is waiting. For point-of-service (POS) printers, availability is critical. A good example would be a kiosk printer in an airport. These printers are typically used for printing boarding passes, receipts, and coupons. A large roll or stack of media is often used to reduce the frequency of service. When the media is low, systems management should automatically alert the appropriate resources that service is required soon. Typically, sensors built into the printer, which roughly gauge the amount of media remaining, detect low paper. This method is often not consistent in measuring from roll to roll and does not provide a level precision that is often required. A second alternative method for detecting low paper is having a visible “end of roll” mark on the paper. This is not acceptable for environments where aesthetic look of the media is important. Another drawback is that this information is only seen by the person reviewing the media and not necessarily by the person who is required to add new media.

Considering the limitations of the aforementioned methods, it is clear that there is a need for a method for sensing an end of roll paper of a printer. In the proposed method a set of second marks are added to side portions of the roll paper to provide additional information to the user of the printer.

### SUMMARY OF THE INVENTION

The shortcomings of the prior art are overcome and additional advantages are provided through the provision of a method for sensing an end of roll paper of a printer, the method comprising: providing one or more back sensors for detecting a set of first marks on the back of the roll paper for aligning text printed on the roll paper, the set of first marks having a first predetermined size; detecting the set of first marks on the back of the roll paper to convey first information to a user of the printer; and detecting a set of second marks to indicate to the user of the printer that the roll paper is ending, set of second marks of a second predetermined size on side portions of the roll paper, the second set of marks having additional information and the second predetermined size being larger than the first predetermined size.

The shortcomings of the prior art are overcome and additional advantages are provided through the provision of a system for sensing an end of roll paper of a printer, the system comprising: a network; and a host system in communication with the network, the host system including software to implement a method comprising: providing one or more back sensors for detecting a set of first marks on the back of the roll paper for aligning text printed on the roll paper, the set of first marks having a first predetermined size; detecting the set of first marks on the back of the roll paper to convey first information to a user of the printer; and detecting a set of second marks to indicate to the user of the printer that the roll paper is ending, set of second marks of a second predetermined size on side portions of the roll paper, the second set of marks having additional information and the second predetermined size being larger than the first predetermined size.

The shortcomings of the prior art are overcome and additional advantages are provided through the provision of a computer program product for sensing an end of roll paper of a printer, the computer program product comprising: a storage medium readable by a processing circuit and storing instructions for execution by the processing circuit for performing a method comprising: providing one or more back sensors for detecting a set of first marks on the back of the roll paper for aligning text printed on the roll paper, the set of first marks having a first predetermined size; detecting the set of first marks on the back of the roll paper to convey first information to a user of the printer; and detecting a set of second marks to indicate to the user of the printer that the roll paper is ending, the set of second marks of a second predetermined size on side portions of the roll paper, the second set of marks having additional information and the second predetermined size being larger than the first predetermined size.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a method of sensing an end of roll paper of a printer.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a pre-printed mark on an airline ticket;

FIG. 2 illustrates one example of a pre-printed mark on an airline ticket including side marks; and

FIG. 3 illustrates one example of a pre-printed mark on an airline ticket including a series of side marks.

### DETAILED DESCRIPTION OF THE INVENTION

One aspect of the exemplary embodiments is an end of roll paper sensing mechanism. Another aspect of the exemplary embodiments is a pre-printed mark or a series of pre-printed marks on the side of roll paper for providing additional marking means.

The use of back mark sensors in a printer is a well-known technology. The back mark sensor is used to detect a black mark on the backside of paper media. The mark has a fixed width, height, and spacing that is used as a reference point by the printer for placement of printing on the front side of the media.

The exemplary embodiments of the present invention describe a mechanism for varying the mark on the back of the paper so that it can be used to convey additional information to the printer and to the system that is using the printer. One specific piece of information that can be conveyed is a low paper warning.

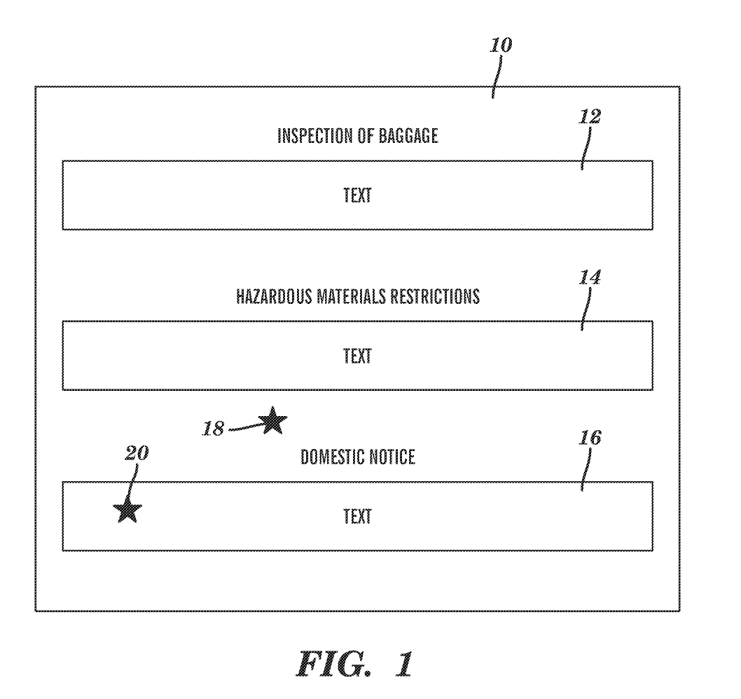

The back mark sensor in a retail printer is used to detect a black mark that is pre-printed on media. An example of a pre-printed mark on a boarding pass for the airline industry is shown in FIG. 1. FIG. 1 shows an airline ticket 10 having an “Inspection of Baggage” section 12, a “Hazardous Materials Restrictions” section 14, a “Domestic Notice” section 16, a first mark 18, and a second mark 20. The first mark 18 and the second mark 20 are considered a set of first marks. Marks 18 and 20 provide a reference point on the media (roll paper) so that pre-printed text on the front and the back of the media properly aligns with the printed text. In the example of FIG. 1, the marks 18 and 20 provide a reference point so that the traveler's name, flight, and other pertinent details are printed in the appropriate spots on the front side of the document. The roll paper pictured in FIG. 1 is most likely purchased as a large roll of media that is cut by the printer as required, based on the back marks 18 and 20. In this example, the airline is interested in minimizing the frequency of changing media but the airline is required to frequently check the status of the media if there is no precise way of detecting low media. Having the media run out in the middle of a customer transaction causes serious customer dissatisfaction.

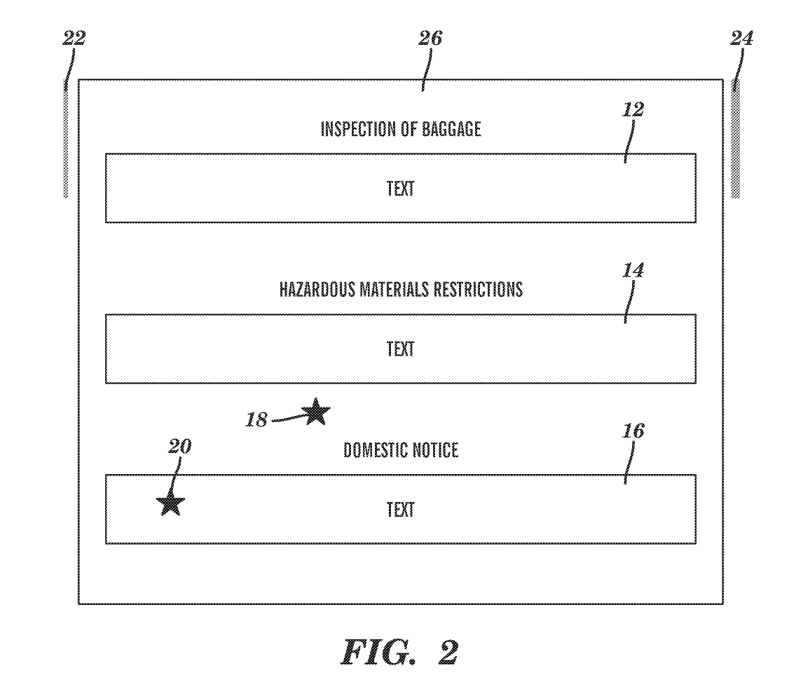

The exemplary embodiments of the present invention modify some property of the marks to provide more information. For instance, the marks may be modified by increasing the height of the mark at a known distance from the end of the roll. For example, referring to FIG. 2, the airline ticket 26 has an “Inspection of Baggage” section 12, a “Hazardous Materials Restrictions” section 14, a “Domestic Notice” section 16, a first mark 18 of a first set of marks, a second mark 20 of a first set of marks, a first mark 22 of a second set of marks, and a second mark 24 of a second set of marks. As illustrated in FIG. 2, the second set of marks 22 and 24 are located at the side portions of the roll paper and above the first set of marks 18 and 20. The second set of marks 22 and 24 are placed before the first set of marks 18 and 20 so as to provide an indication to the user of the printer well before the roll paper ends.

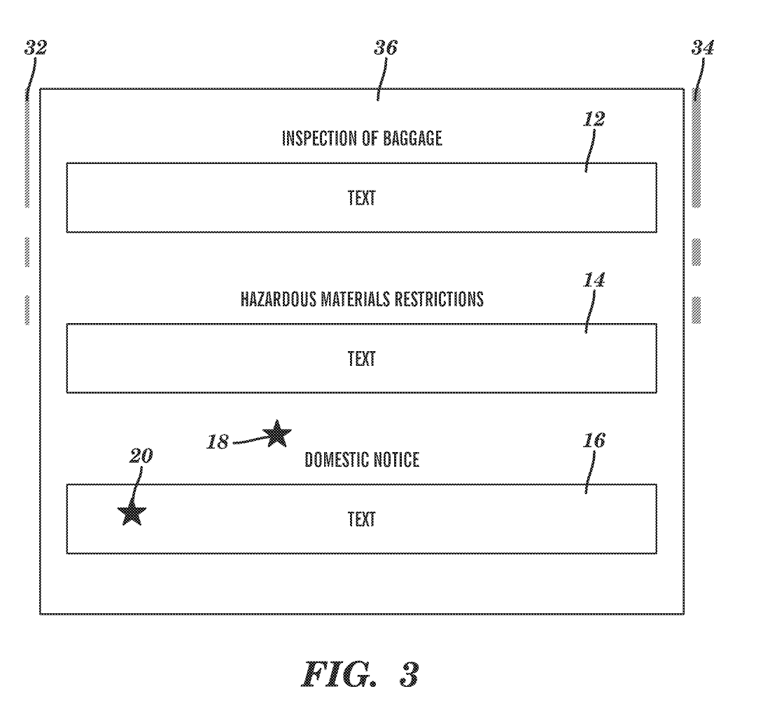

FIG. 3 shows an airline ticket 36 has an “Inspection of Baggage” section 12, a “Hazardous Materials Restrictions” section 14, a “Domestic Notice” section 16, a first mark 18 of a first set of marks, a second mark 20 of a first set of marks, a first series of marks 32 of a second set of marks, and a second series of marks 34 of a second set of marks. As illustrated in FIG. 3, the second set of series of marks 32 and 34 are located at the side portions of the roll paper and above the first set of marks 18 and 20. The second set of series of marks 32 and 34 are placed before the first set of marks 18 and 20 so as to provide an indication to the user of the printer well before the roll paper ends. a section of a roll with two pre-printed forms with text and back marks.

Therefore, the series of marks 32 and 34 shown are longer and indicate that the end of the roll is approaching. The printer firmware also has programmable status indicators that may be returned to the system when the series of marks 32 and 34 are detected. The system operating system (OS) and application would then alert the operators that the paper is low. This type of system management is especially important in multi-printer environments that have varying amounts of customer usage. In the airline example, the most flexibility to the airline is offered by minimizing interruption of the kiosk to check paper status and by removing the need for extra personnel to perform this task on a periodic basis.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for sensing an end of roll paper of a printer, the method comprising:
providing one or more back sensors for detecting a set of first marks on the back of the roll paper for aligning text printed on the roll paper, the set of first marks having a first predetermined size;
detecting the set of first marks on the back of the roll paper to convey first information to a user of the printer; and
detecting a set of second marks to indicate to the user of the printer that the roll paper is ending, the set of second marks of a second predetermined size on side portions of the roll paper, the second set of marks having additional information and the second predetermined size being larger than the first predetermined size.

2. The method of claim 1, wherein the additional information is a low roll paper warning.

3. A system for sensing an end of roll paper of a printer, the system comprising:
a network; and
a host system in communication with the network, the host system including software to implement a method comprising:
providing one or more back sensors for detecting a set of first marks on the back of the roll paper for aligning text printed on the roll paper, the set of first marks having a first predetermined size;
detecting the set of first marks on the back of the roll paper to convey first information to a user of the printer; and
detecting a set of second marks to indicate to the user of the printer that the roll paper is ending, the set of second marks of a second predetermined size on side portions of the roll paper, the second set of marks having additional information and the second predetermined size being larger than the first predetermined size.

4. The system of claim 3, wherein the additional information is a low roll paper warning.

5. A computer program product for sensing an end of roll paper of a printer, the computer program product comprising:
a storage medium readable by a processing circuit and storing instructions for execution by the processing circuit for performing a method comprising:
providing one or more back sensors for detecting a set of first marks on the back of the roll paper for aligning text printed on the roll paper, the set of first marks having a first predetermined size;
detecting the set of first marks on the back of the roll paper to convey first information to a user of the printer; and
detecting a set of second marks to indicate to the user of the printer that the roll paper is ending, the set of second marks of a second predetermined size on side portions of the roll paper, the second set of marks having additional information and the second predetermined size being larger than the first predetermined size.

6. The computer program product of claim 5, wherein the additional information is a low roll paper warning.
